(19) United States
(12) Patent Application Publication
(10) Pub. No.: US 2023/0142741 A1
(43) Pub. Date: May 11, 2023

(54) MANUAL/AUTOMATIC DUAL-PURPOSE CLUTCHING STRUCTURE

(71) Applicant: Dezhao XIANG, Guangdong (CN)

(72) Inventor: Dezhao XIANG, Guangdong (CN)

(21) Appl. No.: 17/520,730

(22) Filed: Nov. 8, 2021

(51) Int. Cl. F16D 9/00; F16D 43/21

(52) U.S. Cl. CPC F16D 9/00; F16D 43/21

(57) ABSTRACT

The manual/automatic dual-purpose clutching structure is characterized by including a driving gear assembly, a clutching assembly and a driven mechanical assembly, where the driving gear assembly includes a first gear, a second gear and driving gear driving components, the first gear being coaxially and fixedly connected to the second gear, a gear of the clutching assembly is located on one side of the second gear of the driving gear assembly and meshes with the first gear, the driven mechanical assembly is located on the other side of the driving gear assembly, but does not make contact with the driving gear assembly, and the gear of the clutching assembly rotates around an axis of the first gear of the driving gear assembly under the driving of the driving gear assembly to mesh with the gear of the driven mechanical assembly.

### BACKGROUND OF THE INVENTION

The present invention relates to the technical field of gear clutching transmission, in particular to a manual/automatic dual-purpose clutching structure.

Locks are used by lock owners to seal up articles. Traditional locksets are of mechanical structures and match adaptive keys for unlocking. With the progress of science and technology and the development of intelligent furniture, electronic locks appear, and “keys” are biological features of lock owners, such as fingerprints, voice prints and faces.

When power is suddenly lost due to short service life, easy failure, etc. of the electronic product, the gear cannot be twisted due to fit jamming of the gear. As a result, the intelligent electronic product cannot be used, resulting in the problems existing in the field of intelligent home, for example, when the rainstorm comes, the window cannot be closed, the curtain cannot be stretched, and the door lock cannot be opened and closed.

### BRIEF SUMMARY OF THE INVENTION

### (1) Technical Problem To Be Solved

Aiming at the defects of the prior art, the present invention provides a manual/automatic dual-purpose clutching structure, which solves the problem that when power is suddenly lost due to short service life, easy failure, etc. of an electronic product in a narrow space, a gear may not be mechanically twisted due to fit jamming of the gear.

### (2) Technical Solution

In order to achieve the above objective, the present invention is achieved by means of the following technical solutions: a manual/automatic two-purpose clutching structure is characterized by including a driving gear assembly, a clutching assembly and a driven mechanical assembly, where

the driving gear assembly includes a first gear, a second gear and driving gear driving components, the first gear being coaxially and fixedly connected to the second gear;

a gear of the clutching assembly is located on one side of the second gear of the driving gear assembly and meshes with the first gear;

the driven mechanical assembly is located on the other side of the driving gear assembly, but does not make contact with the driving gear assembly; and

the gear of the clutching assembly rotates leftwards or rightwards around an axis of the first gear of the driving gear assembly under the driving of the driving gear assembly to mesh with a gear of the driven mechanical assembly, and after power of the driving gear assembly (1) disappears, the clutching gear (2) is prompted to be disengaged from the driven gear (3) under an action of a return spring (4) on the clutching gear (2).

Preferably, the clutching assembly includes a gear carrier, where the gear carrier includes a bottom plate and a top plate, a connecting rod being fixedly connected between the bottom plate and the top plate, the clutching assembly being located on the connecting rod, and one side of the bottom plate being sleeved at the second gear.

Preferably, one side of an upper end of the top plate is fixedly connected with a retaining column, a torsion spring is arranged at the other side of the upper end of the top plate, and one end of the torsion spring abuts against the retaining column.

Preferably, an output shaft is fixedly connected to a middle of the driven mechanical assembly.

Preferably, the driving gear driving components include a transmission gear assembly and a driving motor, where the transmission gear assembly includes a third gear and a fourth gear, the third gear being coaxially and fixedly connected to the fourth gear, and the fourth gear meshing with the first gear.

Preferably, a motor shaft is arranged at one end of the driving motor in an extending manner, a worm is fixedly connected to the motor shaft, and the worm meshes with the third gear.

Preferably, the manual/automatic two-purpose clutching structure further involves a box body and a cover plate, where the clutching structure, the transmission gear assembly and the driving motor are all located inside the box body, and the cover plate is fixed on the box body.

### (3) Beneficial Effects

The present invention provides the manual/automatic dual-purpose clutching structure, and has the following beneficial effects:

the clutching structure of the present invention is simple, has small size, and may be used on a small electronic product.

### BRIEF DESCRIPTION OF THE DRAWINGS

FIG. 1 is a schematic diagram of a clutching structure of the present invention;

FIG. 2 is a schematic diagram of transmission cooperation of the clutching structure of the present invention;

FIG. 3 is a structural schematic diagram of a gear carrier of the present invention; and

FIG. 4 is a structural schematic diagram of the present invention mounted in a box body.

In the figures, 1, driving gear assembly; 2, gear; 3, driven gear; 4, torsion spring; 5, gear carrier; 6, output shaft; 7, transmission gear assembly; 8, worm; 9, driving motor; 10, box body; 11, cover plate;

101, first gear; 102, second gear; 501, bottom plate; 502, connecting rod; 503, retaining column; 504, top plate; 701, third gear; and 702, fourth gear.

### DETAILED DESCRIPTION OF THE INVENTION

The following clearly and completely describes the technical solution of the embodiment of the present invention in conjunction with the accompanying drawings of the embodiment of the present invention. Apparently, the embodiment described is merely some rather than all of the embodiments of the present invention. Based on the embodiment in the present invention, all other embodiments acquired by those of ordinary skill in the art without making creative efforts fall within the scope of protection of the present invention.

### Embodiment

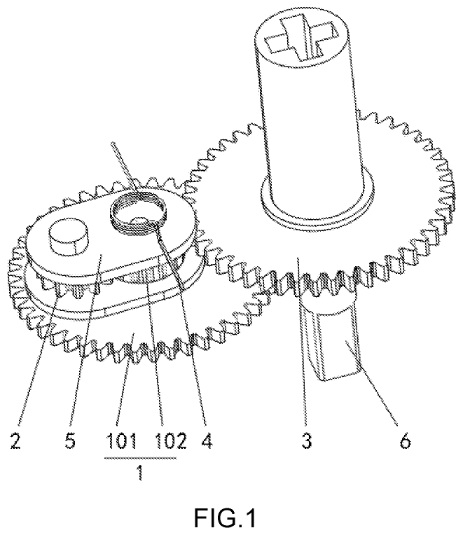

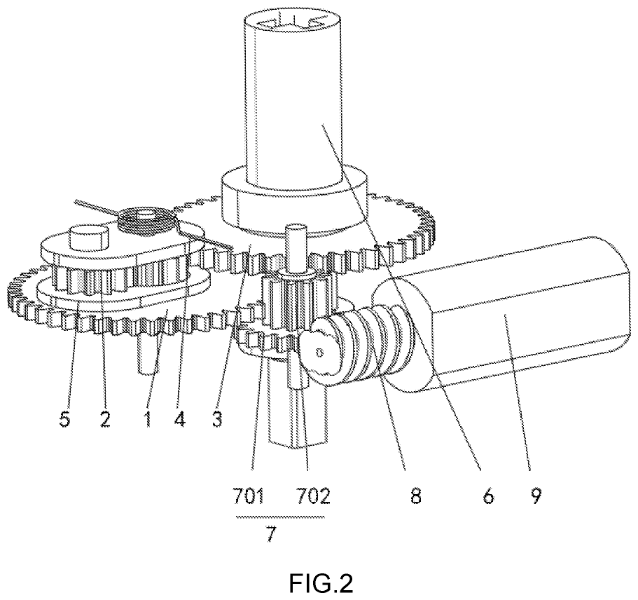

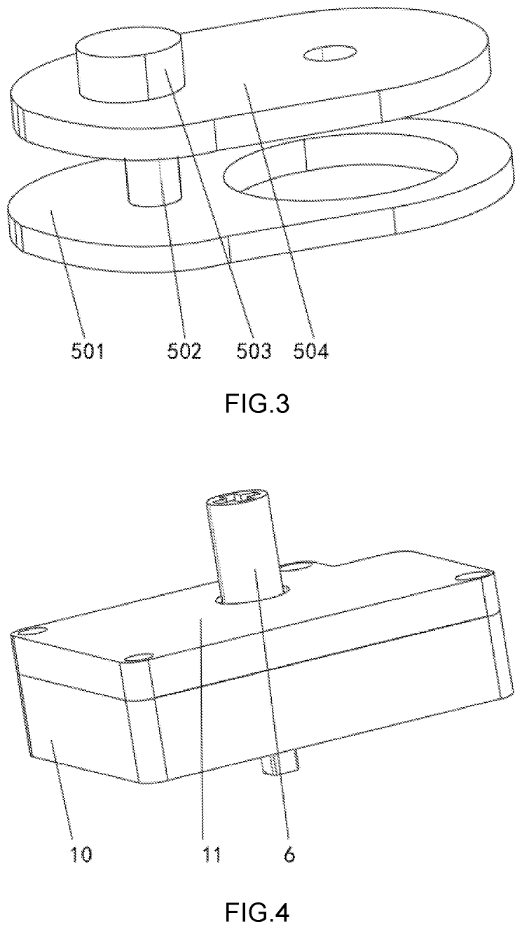

As shown in FIGS. 1-4, the embodiment of the present invention provides a manual/automatic dual-purpose clutching structure. The manual/automatic dual-purpose clutching structure includes a driving gear assembly 1, a clutching assembly (2, 4, 5) and a driven mechanical assembly (3, 6), where the driving gear assembly 1 includes a first gear 101, a second gear 102 and driving gear driving components (7, 8, 9), the first gear 101 being coaxially and fixedly connected to the second gear 102, a gear 2 of the clutching assembly (2, 4, 5) is located on one side of the second gear 102 of the driving gear assembly and meshes with the first gear 101, the driven mechanical assembly (3, 6) is located on the other side of the driving gear assembly 1, but does not make contact with the driving gear assembly, the gear 2 of the clutching assembly (2, 4, 5) rotates around an axis of the first gear 101 of the driving gear assembly 1 under the driving of the driving gear assembly 1 to mesh with a gear 3 of the driven mechanical assembly (3, 6), the clutching assembly 2 rotates around an axis of the driving gear assembly 1 under the driving of the driving gear assembly 1 to mesh with the driven mechanical assembly 3, that is, when the driving gear assembly 1 is in transmission, the clutching assembly 2 is carried to act together until the clutching assembly 2 stops rotating after the clutching assembly 2 meshes with the driven mechanical assembly 3, power of the driving gear assembly 1 is transmitted to the driven mechanical assembly 3 by means of the clutching assembly 2, so as to control a distance between the driven mechanical assembly 3 and the driving gear assembly 1, and when the clutching assembly 2 meshes with the driven mechanical assembly 3 and may not pass through a gap between the driven mechanical assembly 3 and the driving gear assembly 1, the clutching assembly 2 stops rotating along with the driving gear assembly 1.

The clutching assembly (2, 4, 5) includes a gear carrier 5, where the gear carrier 5 includes a bottom plate 501 and a top plate 504, a connecting rod 502 being fixedly connected between the bottom plate 501 and the top plate 504, the clutching 2 being located on the connecting rod 502, one side of the bottom plate 501 being sleeved at the second gear 102, and when the clutching assembly 2 rotates along with the driving gear assembly 1, that is, the gear carrier 5 also rotates along with the driving gear assembly 1, meshing between the clutching assembly 2 and the driven mechanical assembly 3 is achieved.

One side of an upper end of the top plate 504 is fixedly connected with a retaining column 503, a torsion spring 4 is arranged at the other side of the upper end of the top plate 504, one end of the torsion spring 4 abuts against the retaining column 503, when the clutching structure is in use, that is, is mounted in a corresponding housing, the other end of the torsion spring 4 acts on the housing, under an action of no external force, the clutching assembly 2 and the driven mechanical assembly 3 are kept in a disengaged state under an action of the torsion spring 4 on the gear carrier 5, in a process that the gear carrier 5 rotates along with the driving gear assembly 1, the torsion spring 4 may be pressed and accumulates elastic potential energy, and after transmission is finished, that is, the driving gear assembly 1 does not transmit the power any more, the potential energy of the torsion spring 4 is released, such that the clutching assembly 2 is disengaged from the driven mechanical assembly 3, that is, the gear carrier 5 is restored.

The driving gear driving components (7, 8, 9) include a transmission gear assembly 7 and a driving motor 9, where the transmission gear assembly 7 includes a third gear 701 and a fourth gear 702, the third gear 701 being coaxially and fixedly connected to the fourth gear 702, the fourth gear 702 meshing with the first gear 101, the transmission gear assembly 7 has an effect of speed reduction, a motor shaft is arranged at one end of the driving motor 9 in an extending manner, a worm 8 is fixedly connected to the motor shaft, the worm 8 meshes with the third gear 701, cooperation of the worm 8 and the third gear 701 also has an effect of speed reduction, and an appropriate module is selected to ensure that the worm 8 may mesh with the third gear 701, or the third gear 701 is changed into a helical gear.

The manual/automatic dual-purpose clutching structure further involves a box body 10 and a cover plate 11, where the clutching structure, the transmission gear assembly 7 and the driving motor 9 are all located inside the box body 10, a rotating shaft is arranged at middles of the driving gear assembly 1 and a vibration gear 8 in a penetrating manner, two ends of the rotating shaft are fixed to the box body 10 and the cover plate 11 respectively, the cover plate 11 is fixed on the box body 10, an output shaft 6 is fixedly connected to a middle of the driven mechanical assembly 3, and two ends of the output shaft 6 penetrate the box body 10 and the cover plate 11 respectively and are used for power connection of external components.

A working principle is as follows: when the present invention is in use, the driving motor 9 is started, the power is transmitted to the driving gear assembly 1 by means of the transmission gear assembly 7, the driving gear assembly 1 rotates, the gear carrier 5 rotates along with the driving gear assembly at the same time, the torsion spring 5 accumulates a force, and after the clutching gear 2 meshes with the driven mechanical assembly 3, the clutching gear 2 stops rotating along with the driving gear assembly 1, and the power is transmitted to the driven mechanical assembly 3 by means of the clutching gear 2; and after transmission is finished, the gear carrier 5 is restored under an action of the torsion spring 4.

Although the embodiment of the present invention has been illustrated and described, it should be understood that those of ordinary skill in the art may make various changes, modifications, replacements and variations to the above embodiment without departing from the principle and spirit of the present invention, and the scope of the present invention is limited by the appended claims and their legal equivalents.

What is claimed is:

1. A manual/automatic dual-purpose clutching structure, comprising a driving gear assembly (1), a clutching assembly (2, 4, 5) and a driven mechanical assembly (3, 6), wherein
the driving gear assembly (1) comprises a first gear (101), a second gear (102) and driving gear driving components (7, 8, 9), the first gear (101) being coaxially and fixedly connected to the second gear (102);
a gear (2) of the clutching assembly (2, 4, 5) is located on one side of the second gear (102) of the driving gear assembly and meshes with the first gear (101);
the driven mechanical assembly (3, 6) is located on the other side of the driving gear assembly (1), but does not make contact with the driving gear assembly;
the gear (2) of the clutching assembly (2, 4, 5) rotates leftwards or rightwards around an axis of the first gear (101) of the driving gear assembly under the driving of the driving gear assembly (1) to mesh with a gear (3) of the driven mechanical assembly (3, 6); and after power of the driving gear assembly (1) disappears, the clutching gear (2) is prompted to be disengaged from the driven gear (3) under an action of a return spring (4) on the clutching gear (2).

2. The manual/automatic dual-purpose clutching structure according to claim 1, characterized in that the clutching assembly (2, 4, 5) comprises a gear carrier (5), wherein the gear carrier (5) comprises a bottom plate (501) and a top plate (504), a connecting rod (502) being fixedly connected between the bottom plate (501) and the top plate (504), the gear (2) being located on the connecting rod (502), and one side of the bottom plate (501) being sleeved at the second gear (102).

3. The manual/automatic dual-purpose clutching structure according to claim 3, characterized in that one side of an upper end of the top plate (504) is fixedly connected with a retaining column (503), a torsion spring (4) is arranged at the other side of the upper end of the top plate (504), and one end of the torsion spring (4) abuts against the retaining column (503).

4. The manual/automatic dual-purpose clutching structure according to claim 1, characterized in that the driving gear driving components (7, 8, 9) comprise a transmission gear assembly (7) and a driving motor (9), wherein the transmission gear assembly (7) comprises a third gear (701) and a fourth gear (702), the third gear (701) being coaxially and fixedly connected to the fourth gear (702), and the fourth gear (702) meshing with the first gear (101).

5. The manual/automatic dual-purpose clutching structure according to claim 4, characterized in that a motor shaft is arranged at one end of the driving motor (9) in an extending manner, a worm (8) is fixedly connected to the motor shaft, and the worm (8) meshes with the third gear (701).

6. The manual/automatic dual-purpose clutching structure according to claim 4, further involving a box body (10) and a cover plate (11), and characterized in that the clutching structure, the transmission gear assembly (7) and the driving motor (9) are all located inside the box body (10), and the cover plate (11) is fixed on the box body (10).
